(19) United States
(12) Patent Application Publication
(10) Pub. No.: US 2025/0219106 A1
(43) Pub. Date: Jul. 3, 2025

(54) JIG FOR SHEET MATERIAL AND METHOD OF MANUFACTURING SHEET MATERIAL

(71) Applicant: HONDA MOTOR CO., LTD., Tokyo (JP)

(72) Inventors: Fumiyoshi KUROSU, Saitama (JP); Naoki KUSHITANI, Saitama (JP)

(21) Appl. No.: 19/001,890

(22) Filed: Dec. 26, 2024

(30) Foreign Application Priority Data
Dec. 28, 2023 (JP) 2023-223114

(51) Int. Cl. H01M 4/88

(52) U.S. Cl. CPC H01M 4/8825; H01M 4/8807

(57) ABSTRACT

Provided are a jig for a sheet material and a method of manufacturing a sheet material that are capable of preventing or reducing contamination due to exfoliation of flakes of a MPL and enable accurate manufacture of a sheet having a gas diffusion layer and an electrode catalyst layer. A jig for a sheet material includes: a SUS jig as a support member that supports an end portion located outside a to-be-coated region of the sheet material from one side in a thickness direction of the sheet material; and a magnet as a fixing member that clamps and fixes, in cooperation with the SUS jig, the end portion of the sheet material from the other side in the thickness direction.

This application is based on and claims the benefit of priority from Japanese Patent Application No. 2023-223114, filed on 28 Dec. 2023, the content of which is incorporated herein by reference.

### BACKGROUND OF THE INVENTION

### Field of the Invention

The present invention relates to a jig for a sheet material and a method of manufacturing a sheet material.

### Related Art

Conventionally, a sheet-shaped catalyst-coated diffusion medium (CCDM) has been used as a material for forming a membrane electrode assembly. A sheet-shaped catalyst-coated diffusion medium of this type is described, for example, in Japanese Unexamined Patent Application, Publication No. 2018-101481

Patent Document 1: Japanese Unexamined Patent Application, Publication No. 2018-101481

### SUMMARY OF THE INVENTION

To manufacture catalyst-coated diffusion media in sheet form, a sheet material (GDL) having a gas diffusion layer formed thereon is set on a desktop die coater, and an electrode catalyst layer is formed, by a coating process, on a surface of the sheet material (GDL) set on the desktop die coater.

The GDL is fixed onto a porous ceramic jig by means of an adhesive sheet and air suction using the porous ceramic jig. Therefore, when the sheet-shaped catalyst-coated diffusion medium including the GDL and the electrode catalyst layer formed on the GDL is peeled off from the desktop die coater after the coating process, the sheet-shaped catalyst-coated diffusion medium is inclined, and flakes of a micro porous layer (MPL) exfoliate. The exfoliation of flakes of the MPL causes contamination of a surface of the catalyst-coated diffusion medium.

The present invention has an object to provide a jig for a sheet material and a method of manufacturing a sheet material that are capable of preventing or reducing contamination due to exfoliation of flakes of a MPL and enable accurate manufacture of a sheet having a gas diffusion layer and an electrode catalyst layer.

A first aspect of the present invention is directed to a jig (e.g., a jig 10 to be described later) for fixing a sheet material (e.g., a sheet material 60 to be described later) having a gas diffusion layer in a coater (e.g., a coater 1 to be described later) that forms an electrode catalyst layer on the sheet material by a coating process. The jig includes: a support member (e.g., a SUS jig 40 to be described later) that supports an end portion (e.g., an end portion 62 to be described later) of the sheet material, from one side in a thickness direction of the sheet material, the end portion being located outside a to-be-coated region (e.g., a to-be-coated region 61 to be described later) of the sheet material; and a fixing member (e.g., a magnet 50 to be described later) that clamps and fixes, in cooperation with the support member, the end portion of the sheet material from an other side in the thickness direction.

According to a second aspect, the jig of the first aspect may further include a support platform (e.g., a support platform 22 to be described later) that supports a back side of the to-be-coated region of the sheet material from the one side in the thickness direction.

According to a third aspect, the jig of the second aspect may further include an adhesive sheet (e.g., an adhesive sheet 25 to be described later) that is disposed on a support surface of the support platform and adheres to a back side of the sheet material.

According to a fourth aspect, in the jig of the third aspect, a portion of the support member that supports the end portion of the sheet material has a length in the thickness direction, and the length may be set to a length obtained by adding a thickness of the adhesive sheet to a height of the support platform.

According to a fifth aspect, in the jig of any one of the first to fourth aspects, the fixing member may include a magnet, and the support member may be made of a metal that is attracted to the fixing member by magnetic force.

A sixth aspect of the present invention is directed to a method of manufacturing a sheet material (e.g., a sheet material 60 to be described later) including a gas diffusion layer and an electrode catalyst layer. The method includes: forming the electrode catalyst layer by a coating process in a state in which the sheet material having the gas diffusion layer is fixed by a support member (e.g., a SUS jig 40 to be described later) and a fixing member (e.g., a magnet 50 to be described later), the support member supporting, from one side in a thickness direction of the sheet material, an end portion (e.g., an end portion 62 to be described later) of the sheet material, the end portion being located outside a to-be-coated region (e.g., a to-be-coated region 61 to be described later) of the sheet material, the fixing member clamping and fixing, in cooperation with the support member, the end portion of the sheet material from an other side in the thickness direction; moving the sheet material having the electrode catalyst layer formed thereon upward away from a coating position while the sheet material remains fixed by the support member and the fixing member; and
placing the sheet material in a drying oven (e.g., a drying oven 5 to be described later) while the sheet material remains fixed by the support member and the fixing member.

The present invention provides a jig for a sheet material and a method of manufacturing a sheet material that are capable of preventing or reducing contamination due to exfoliation of flakes of a MPL and enable accurate manufacture of a sheet having a gas diffusion layer and an electrode catalyst layer.

### BRIEF DESCRIPTION OF THE DRAWINGS

FIG. 1 is a schematic diagram illustrating a state in which a jig for a sheet material according to an embodiment of the present invention is disposed in a coater;

FIG. 2 is a perspective view illustrating a porous ceramic jig and a SUS jig included in the jig for a sheet material of the embodiment;

FIG. 3 is a cross-sectional view of the porous ceramic jig disposed on a table die surface plate;

FIG. 4 is a cross-sectional view of the porous ceramic jig and the SUS jig to which a sheet material is fixed;

FIG. 5 is a cross-sectional view of the porous ceramic jig and the SUS jig to which the sheet material in a coating process is fixed;

FIG. 6 is a perspective view illustrating a state in which the SUS jig to which the sheet material having an electrode catalyst layer formed thereon is fixed is separated from the porous ceramic jig;

FIG. 7 is a schematic diagram illustrating a state in which the SUS jig to which the sheet material having the electrode catalyst layer formed thereon is fixed is placed in a drying oven; and

FIG. 8 is a schematic diagram illustrating flakes of a MPL that are generated in a conventional manner in which a sheet material is peeled off while being inclined.

### DETAILED DESCRIPTION OF THE INVENTION

An embodiment of the present invention will be described below with reference to the drawings.

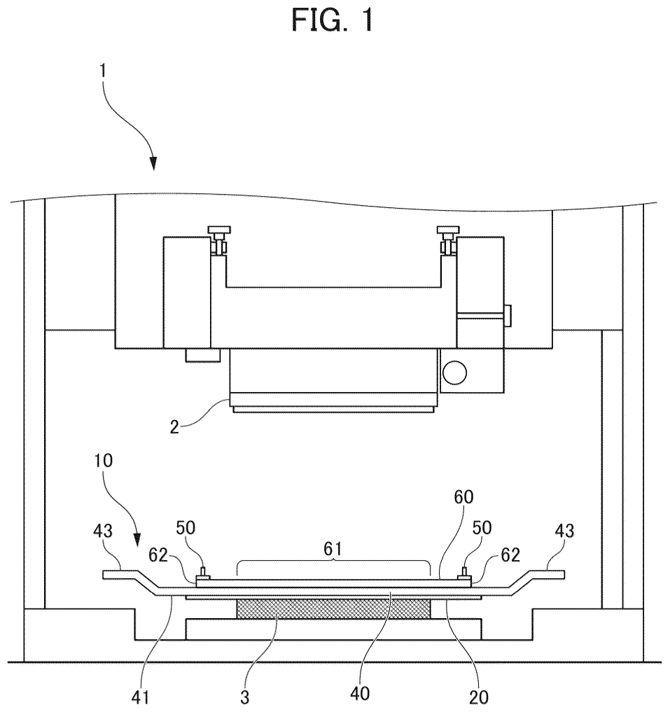

FIG. 1 is a schematic diagram illustrating a state in which a jig 10 for a sheet material 60 according to an embodiment of the present invention is disposed in a coater 1. The coater 1 illustrated in FIG. 1 is a tabletop die coater that forms a coating layer having a uniform thickness on the sheet material 60 that is a coating target.

In the present embodiment, the sheet material 60 as the coating target is GDL including a carbon paper as a base material and a gas diffusion layer formed on the base material. The coater 1 forms, as a coating layer, an electrode catalyst layer on the sheet material 60. The electrode catalyst layer is, for example, a cathode electrode including a carbon material and Pt or the like supported on the carbon material.

The coater 1 forms the electrode catalyst layer on the GDL by a coating process, thereby producing a catalyst-coated diffusion medium (CCDM) including the electrode catalyst layer and the gas diffusion layer.

The coater 1 of the present embodiment includes a slot die 2 for forming a coating layer having a uniform thickness on the sheet material 60, and a table die surface plate 3 where the sheet material 60 on which the coating layer is formed by the slot die 2 is placed. The table die surface plate 3 has a suction function of attracting by air suction the sheet material 60 set on the jig 10. Due to this suction function, the coating target is stably held in position.

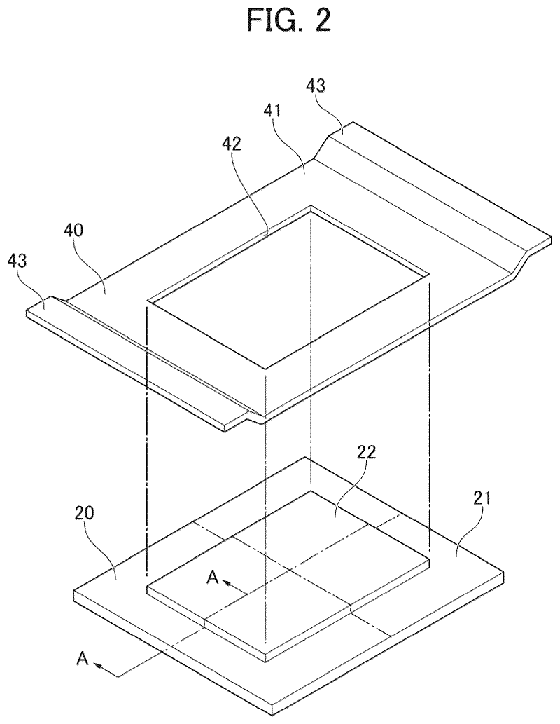

Referring to FIG. 2, the jig 10 that is used for fixing the sheet material 60 in the coater 1, which forms by a coating process the electrode catalyst layer on the sheet material 60 having the gas diffusion layer, will be described. FIG. 2 is a perspective view illustrating a porous ceramic jig 20 and a SUS jig 40 included in the jig 10 for the sheet material 60 of the present embodiment. As illustrated in FIG. 2, the jig 10 includes the porous ceramic jig 20 and the SUS jig 40.

The porous ceramic jig 20 is made of ceramic (porous body) having a large number of pores therein. The porous ceramic jig 20 is disposed on the table die surface plate 3. The suction force of the table die surface plate 3 and the pores of the porous ceramic jig 20 generate a negative pressure on the upper surface of the porous ceramic jig 20.

The porous ceramic jig 20 of the present embodiment includes a base 21 that has a flat plate shape and is disposed on the table die surface plate 3, and a support platform 22 located at the center of the base 21. Due to the base 21 and the support platform 22, the porous ceramic jig 20 has a step on its upper surface. In the present embodiment, the base 21 and the support platform 22 are integrally formed with each other.

The SUS jig 40 is made of stainless steel (metal) that is attracted to a magnet. In the present embodiment, the SUS jig 40 is disposed on top of the porous ceramic jig 20.

The SUS jig 40 of the present embodiment includes a frame portion 41 that has a rectangular hole 42 formed at the center thereof and corresponding to the shape of the support platform 22, and bent portions 43 provided on both sides of the frame portion 41. The frame portion 41 functions as a clamp portion that clamps end portions 62 of the sheet material 60 in cooperation with magnets 50 to be described later. Each bent portion 43 extends obliquely upward from the frame portion 41 in an outward direction and then extends further outward in the horizontal direction. Each bent portion 43 can function as a grip portion when the SUS jig 40 is attached and detached.

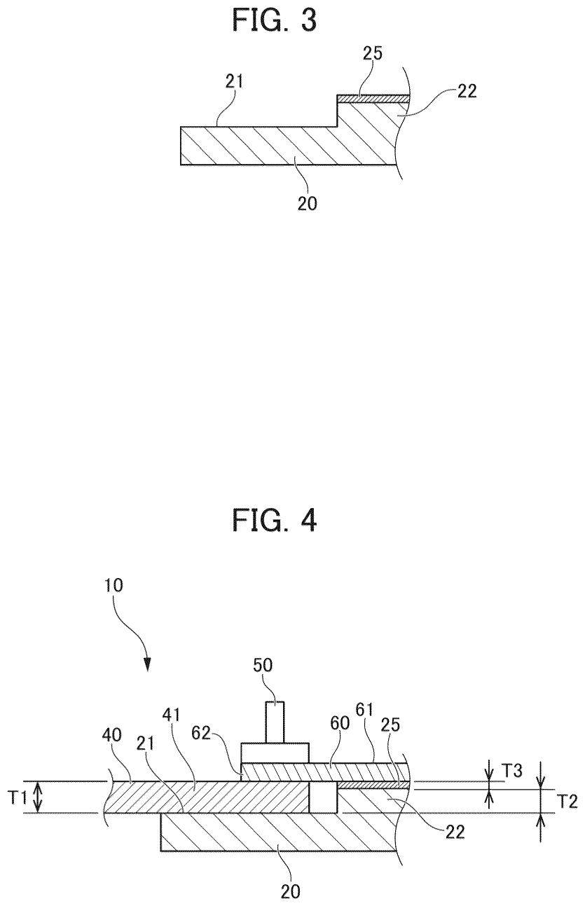

Next, a process of manufacturing a catalyst-coated diffusion medium (CCDM) by forming an electrode catalyst layer 65 on the sheet material 60 having the gas diffusion layer formed thereon will be described with reference to FIGS. 3 to 7.

FIG. 3 is a cross-sectional view of the porous ceramic jig 20 disposed on the table die surface plate 3. FIG. 3 illustrates a cross section viewed along arrows A-A in FIG. 2. As illustrated in FIG. 3, an adhesive sheet 25 is disposed on the upper surface (support surface) of the support platform 22 of the porous ceramic jig 20. The adhesive sheet 25 according to the present embodiment has no adhesive region on the lower surface and an adhesive region on the upper surface that comes into contact with the sheet material 60. The lower surface of the adhesive sheet 25 is subjected to air suction by the table die surface plate 3.

FIG. 4 is a cross-sectional view of the porous ceramic jig 20 and the SUS jig 40 to which the sheet material 60 is fixed. First, a fixing operation is performed in advance to fix the sheet material 60 by the SUS jig 40 and the magnets 50. In the fixing operation for fixing the sheet material 60, the sheet material 60 is disposed such that a to-be-coated region 61 of the sheet material 60 overlaps with the rectangular hole 42 of the frame portion 41 of the SUS jig 40 and the end portions 62 of the sheet material 60 are supported by the frame portion 41 from below. The end portions 62 of the sheet material 60 are located outside the to-be-coated region 61 of the sheet material 60 and outside the rectangular hole 42.

In a state in which the sheet material 60 is disposed on the SUS jig 40, the magnets 50 are disposed on the end portions 62 of the sheet material 60. A plurality of the magnets 50 are disposed. In the present embodiment, four magnets 50 are disposed at the four corners of the sheet material 60 having a rectangular shape. Thus, a state in which the end portions 62 of the sheet material 60 are clamped in the vertical direction between the SUS jig 40 having a magnetic substance and the magnets 50 is brought about. The fixing operation for fixing the sheet material 60 may be performed in advance in another place using a setting jig (not shown).

The sheet material 60 fixed by the SUS jig 40 and the magnets 50 is disposed on the porous ceramic jig 20. The SUS jig 40 is disposed such that the support platform 22 of the porous ceramic jig 20 is positioned in the rectangular hole 42 of the frame portion 41. The back surface of the to-be-coated region 61 of the sheet material 60 is then made to adhere to and held on the upper surface of the adhesive sheet 25 that is fixed by suction to the support platform 22.

A length of the frame portion 41 of the SUS jig 40 in the thickness direction is denoted by T1, a height (length in the thickness direction) of the support platform 22 protruding from the base 21 of the porous ceramic jig 20 is denoted by T2, and a length of the adhesive sheet 25 in the thickness direction is denoted by T3. In the present embodiment, the SUS jig 40, the porous ceramic jig 20, and the adhesive sheet 25 are configured such that T1=T2+T3 is satisfied. In this example, the thickness direction coincides with the vertical direction, and the upper surface of the frame portion 41 of the SUS jig 40 and the upper surface of the adhesive sheet 25 are at the same position in the height direction. Therefore, the to-be-coated region 61 and the end portions 62 of the sheet material 60 are held at the same height.

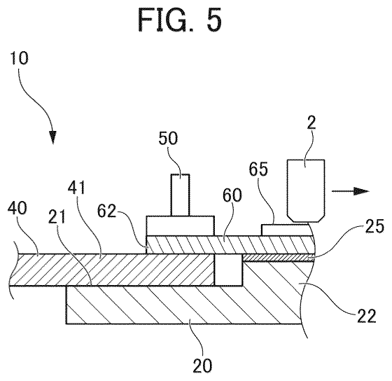

FIG. 5 is a cross-sectional view of the porous ceramic jig 20 and the SUS jig 40 to which the sheet material 60 in a coating process is fixed. As illustrated in FIG. 5, the coating process is performed in a state in which the sheet material 60 is fixed by the jig 10. The electrode catalyst layer 65 is formed on the sheet material 60 by this coating process.

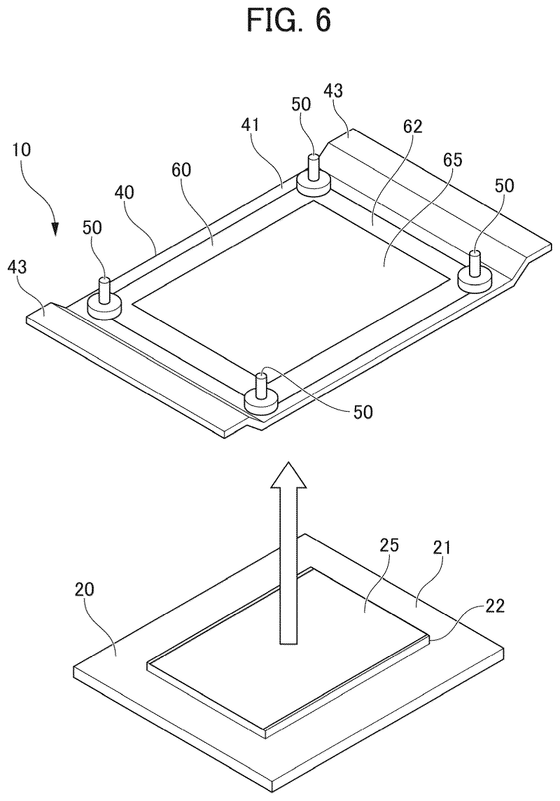

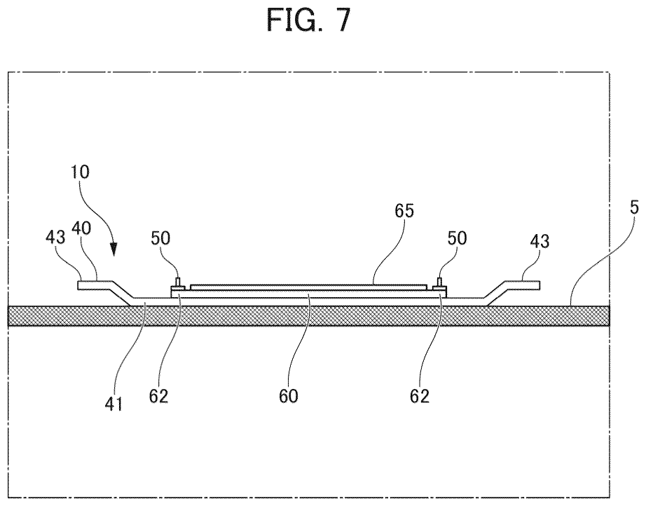

FIG. 6 is a perspective view illustrating a state in which the SUS jig 40, to which the sheet material 60 having the electrode catalyst layer 65 formed thereon is fixed, is separated from the porous ceramic jig 20. As illustrated in FIG. 6, in order to take out the sheet material 60 having the electrode catalyst layer 65 formed thereon from the coater 1, the SUS jig 40 is moved upward away from the porous ceramic jig 20 without removing the magnets 50. Due to being fixed by the magnets 50 and the SUS jig 40, the sheet material 60 having the electrode catalyst layer 65 formed thereon also moves integrally with the SUS jig 40.

The adhesiveness of the adhesive sheet 25 is set to such a level that the adhesive sheet 25 easily separates from the lower surface of the sheet material 60 in accordance with the upward movement of the SUS jig 40.

FIG. 7 is a schematic diagram illustrating a state in which the SUS jig 40, to which the sheet material 60 having the electrode catalyst layer 65 formed thereon is fixed, is placed in a drying oven 5. As illustrated in FIG. 7, after completion of the coating process, the sheet material 60 having the electrode catalyst layer 65 formed thereon is loaded into the drying oven 5 together with the magnets 50 and the SUS jig 40. For example, the sheet material 60 is placed at a drying position in the drying oven 5 by being moved in the horizontal direction together with the magnets 50 and the SUS jig 40.

The sheet material 60 having thereon the electrode catalyst layer 65 is moved into the drying oven 5 while the sheet material 60 remains fixed by the magnets 50 and the SUS jig 40. After being subjected to a drying process in the drying oven 5, the sheet material 60 as a catalyst-coated diffusion medium (CCDM) is obtained as a product.

As described above, a jig 10 for a sheet material 60 according to the present embodiment includes a SUS jig 40 as a support member that supports end portions 62 located outside a to-be-coated region 61 of the sheet material 60 from one side in a thickness direction of the sheet material 60, and magnets 50 as fixing members that clamp and fix, in cooperation with the SUS jig 40, the end portions 62 of the sheet material 60 from the other side in the thickness direction.

A method of manufacturing a sheet material 60 having a gas diffusion layer and an electrode catalyst layer 65 includes: a step of forming the electrode catalyst layer 65 by a coating process in a state in which the sheet material 60 having the gas diffusion layer is fixed by a SUS jig 40 and magnets 50, the SUS jig 40 functioning as a support member that supports, from one side (lower side) in the thickness direction of the sheet material 60, end portions 62 located outside a to-be-coated region 61 of the sheet material 60, the magnets 50 clamping and fixing, in cooperation with the SUS jig 40, the end portions 62 of the sheet material 60 from the other side (upper side) in the thickness direction; a step of moving the sheet material 60 having the electrode catalyst layer 65 formed thereon upward away from a coating position while the sheet material 60 remains fixed by the SUS jig 40 and the magnets 50; and a step of placing the sheet material 60 in a drying oven 5 while the sheet material 60 remains fixed by the SUS jig 40 and the magnets 50.

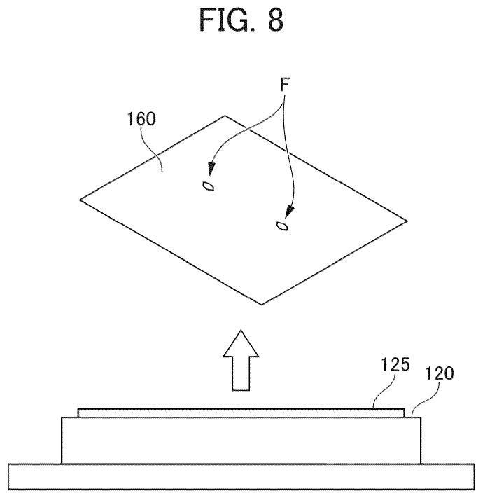

Here, a conventional example will be described with reference to FIG. 8. FIG. 8 is a schematic diagram illustrating flakes F of a micro porous layer (MPL) that are generated in a conventional manner in which a sheet material 160 is peeled off while being inclined. FIG. 8 illustrates a state in which the sheet material 160 subjected to a coating process is removed from an adhesive sheet 125 fixed by air suction to a porous ceramic jig 120. According to this manner, since the sheet material 160 is peeled off while being inclined, flakes F of the MPL exfoliate from a surface of the sheet material 160. The exfoliation of flakes F of the MPL from the surface of the sheet material 160 allows ingress of foreign matter and causes contamination of the surface of the sheet material 160.

In contrast, according to the jig 10 for the sheet material 60 and the method of manufacturing the sheet material 60 of the present embodiment, during the process of taking out the sheet material 60 subjected to the coating process from the coater 1 and loading the sheet material 60 into the drying oven 5, the sheet material 60 can be vertically lifted from the coating position together with the SUS jig 40 and the magnets 50, and can be prevented from being inclined. In this way, it is possible to easily move the sheet material 60 subjected to the coating process from the coater 1 to the drying oven 5 while preventing or reducing contamination by eliminating or reducing the likelihood of exfoliation of flakes F of the MPL.

The jig 10 of the present embodiment further includes a support platform 22 that supports the back side of the to-be-coated region 61 of the sheet material 60 from the one side in the thickness direction.

This feature makes it possible to more stably fix the to-be-coated region 61 of the sheet material 60.

The jig 10 of the present embodiment further includes an adhesive sheet 25 that is disposed on the support surface of the support platform 22 and adheres to the back side of the sheet material 60.

Due to this feature, the back side of the sheet material 60 is fixed by the adhesiveness of the adhesive sheet 25, thereby making it possible to avoid a situation in which the sheet material 60 having undulations is subjected to the coating process. Thus, the coating process can be performed more accurately. A step may be performed in which a PET film or the like is disposed on the to-be-coated region 61 of the sheet material 60 and in which the sheet material 60 having thereon the PET film or the like and the adhesive sheet 25 are brought into tight contact with each other by a roller. As a result, the adhesion between the sheet material 60 and the adhesive sheet 25 can be increased while protecting the to-be-coated region 61, and undulations can be more effectively reduced or prevented.

In the present embodiment, the length T1 in the thickness direction of the frame portion 41, which belongs to the SUS jig 40 and supports the end portions 62 of the sheet material 60, is set to a length obtained by adding the thickness T3 of the adhesive sheet 25 to the height T2 of the support platform 22.

Due to this feature, the to-be-coated region 61 of the sheet material 60 and the end portions 62 located outside the to-be-coated region 61 are at the same height, whereby the sheet material 60 is stably maintained in a horizontal posture and the coating process can be performed more accurately.

In the present embodiment, the magnets 50 constitute fixing members, and the SUS jig 40 is made of a metal that is attracted to the magnets 50 by magnetic force.

This feature facilitates the fixing operation for fixing the sheet material 60 with the help of the magnets, without damaging the sheet material 60.

It should be noted that the present invention is not limited to the embodiment described above. Furthermore, the effects described in the above embodiment are merely examples of favorable effects, and the effects of the present invention are not limited to those described in the above embodiment.

### EXPLANATION OF REFERENCE NUMERALS

1: Coater
5: Drying oven
10: Jig
20: Porous ceramic jig
22: Support platform
25: Adhesive sheet
40: SUS jig (support member)
50: Magnet (fixing member)
60: Sheet material
61: To-be-coated region
62: End portion
F: Flake of MPL

What is claimed is:

1. A jig for fixing a sheet material having a gas diffusion layer in a coater that forms an electrode catalyst layer on the sheet material by a coating process, the jig comprising:
a support member that supports an end portion of the sheet material from one side in a thickness direction of the sheet material, the end portion being located outside a to-be-coated region of the sheet material; and
a fixing member that clamps and fixes, in cooperation with the support member, the end portion of the sheet material from an other side in the thickness direction.

2. The jig according to claim 1, further comprising:
a support platform that supports a back side of the to-be-coated region of the sheet material from the one side in the thickness direction.

3. The jig according to claim 2, further comprising:
an adhesive sheet that is disposed on a support surface of the support platform and adheres to a back side of the sheet material.

4. The jig according to claim 3, wherein
a portion of the support member that supports the end portion of the sheet material has a length in the thickness direction, the length being set to a length obtained by adding a thickness of the adhesive sheet to a height of the support platform.

5. The jig according to claim 1, wherein
the fixing member comprises a magnet, and
the support member is made of a metal that is attracted to the fixing member by magnetic force.

6. A method of manufacturing a sheet material including a gas diffusion layer and an electrode catalyst layer, the method comprising:
forming the electrode catalyst layer by a coating process in a state in which the sheet material having the gas diffusion layer is fixed by a support member and a fixing member,
the support member supporting, from one side in a thickness direction of the sheet material, an end portion of the sheet material, the end portion being located outside a to-be-coated region of the sheet material,
the fixing member clamping and fixing, in cooperation with the support member, the end portion of the sheet material from an other side in the thickness direction;
moving the sheet material having the electrode catalyst layer formed thereon upward away from a coating position while the sheet material remains fixed by the support member and the fixing member; and
placing the sheet material in a drying oven while the sheet material remains fixed by the support member and the fixing member.
